(19) United States
(12) Patent Application Publication
(10) Pub. No.: US 2014/0329203 A1
(43) Pub. Date: Nov. 6, 2014

(54) METHOD FOR SEATING A DENTAL RESTORATION

(71) Applicant: Ardavan Saidi, Miami Beach, FL (US)

(72) Inventor: Ardavan Saidi, Miami Beach, FL (US)

(21) Appl. No.: 14/267,314

(22) Filed: May 1, 2014

Related U.S. Application Data
(60) Provisional application No. 61/817,952, filed on May 1, 2013.

(51) Int. Cl. A61C 13/00

(52) U.S. Cl. CPC A61C 13/0024
USPC 433/196

(57) ABSTRACT

The present invention relates to a method for exceeding a dental restoration whereby the method includes measurement of the distance between a restoration and an adjacent tooth, resizing the restoration as needed, and permanently affixing the restoration in the mouth of the patient.

### INDEX TO RELATED APPLICATIONS

This application is a non-provisional of, and claims benefit to, U.S. Provisional Patent Application Ser. No. 61/817,952, filed May 1, 2013 the disclosure of which is incorporated herein by reference in its entirety.

### BACKGROUND OF THE INVENTION

An important and delicate task of many dental practitioners concerns the seating of a dental restoration. Dental restorations include but are note not limited to crowns, inlays, onlays, bridges, and the like.

The skilled dental practitioner is charged with the task of precise placement and securing of a restoration in the mouth of the patient.

Currently, the dental practitioner will use a ribbon between the restoration and each adjacent tooth.

The ribbon is typically configured with a dye or other colorimetric indicator that produces a spot on the dental restoration such that the practitioner understands the precise point or points of contact between a restoration and each adjacent tooth.

When a typical restoration has been shaped and positioned the dental practitioner will then attempt to seat dental floss between each adjacent tooth and the restoration.

This process of final shaping and measurement using dental floss is often repeated and includes multiple uses of ribbon followed by measurement utilizing dental floss.

The present invention addresses duplicate of steps by providing a dental floss with an appropriate dye or pressure sensitive color indicator whereby the skill dental practitioner can utilize a single article in determining suitability and final placement of a dental restoration.

### SUMMARY OF THE INVENTION

Often in dental restoration the crown's contour is too wide and does not seat. properly. Typically it is due to how originally the restorations come from the oven or casting in the lab, due to marginal error, and the fact that is easier to remove than to add to the restoration.

Currently the interference is measured using a thin articulating paper similar to duplicating carbon copy paper. When required, the adjustment in size is made by carefully grinding or drilling the nigh interproximal contact surface. Once adjustment is finished, the final seating of the restoration provides a width that is just perfect enough to snap a dental floss without tearing it. The space between the restoration and the tooth is not too wide not too narrow (in general, almost 50 micron greater than the existing distant between the two adjacent teeth).

The proper newton force on the contact areas, in general, must be less than the tensile strength of the glide or dental floss so it does not break the floss.

Currently, these steps are time consuming and need to be repeated numerous times in order to achieve the perfect contact pressure and intermittently floss should be used to feel the magnitude of the interproximal pressure. This is accomplished by the skilled dental practitioner and is based totally on tactile senses.

Contact indicating floss of the present invention, in one embodiment, is an impregnated floss (or glide) that combines these objectives into one.

First it is much easier to use floss in the mouth verses a paper (the paper constantly gets wet n bent).

Secondly, by leaving the residual ink (marking) on the contact points, two objectives can be achieved in one:
1—The interference high pressure contact points between the restoration and tooth can be identified so It can be adjusted; and
2—With doctor's tactile senses on how the floss feels like, he/she can drill (remove) the material accordingly (proportionally)

Thus the present invention is a much easier and faster when using contact indicating floss.

In one embodiment, the present invention provides:

A method for the proper seating of a dental restoration, the method comprising the steps of:
providing a dental floss having disposed thereon at least one material constructed and arranged to produce a spot or visible color change on a dental restoration when said floss is brought in pressurized contact with at least one surface:
positioning a dental restoration on a prep tooth in the mouth of a patient;
positioning said dental floss on the uppermost region between said dental restoration and an adjacent tooth;
applying pressure on said dental floss in order to push said dental floss to the region along the gum line between said restoration and said adjacent tooth, wherein said pressure causes said dental floss to contact the surface of each said restoration and said adjacent tooth;
producing a visible mark on said restoration wherein said mark is indicative of the region of closest proximity between said restoration and said adjacent tooth;
optionally, resizing said restoration based upon said visible mark and said pressure required to push said dental floss to the regional on the gum line between said restoration and said at the adjacent tooth;
optionally, repeating any of the above steps as necessary until the dental practitioner perceives said dental restoration to be of proper size.

In one embodiment, the material disposed on the floss is affixed during manufacture of said floss.

In another embodiment, the material disposed on the floss is disposed on said floss prior to use. For example, immediately before use, or in close proximity of use such as 5, 10, or 20 minutes before use.

The spot or visible color change on said floss only occurs in a region resultant to application of pressure while the remainder of the floss remains with unchanged color.

In one embodiment, the spot or visible color change on said floss is permanent.

In another embodiment, the spot or visible color change on said floss is a reversible color change.

### BRIEF DESCRIPTION OF THE SEVERAL VIEWS OF THE DRAWING

FIG. 1 demonstrates that floss of the present invention creates a colored region on a restoration indicating to the dental practitioner a region where the restoration needs to be resized.

FIG. 2 is a close up perspective view of a tooth exhibiting a colored region produced according to the present invention.

FIG. 3 shows the floss of the present invention producing a colored region on a dental restoration indicating a point of contact between the restoration and the immediately adjacent tooth.

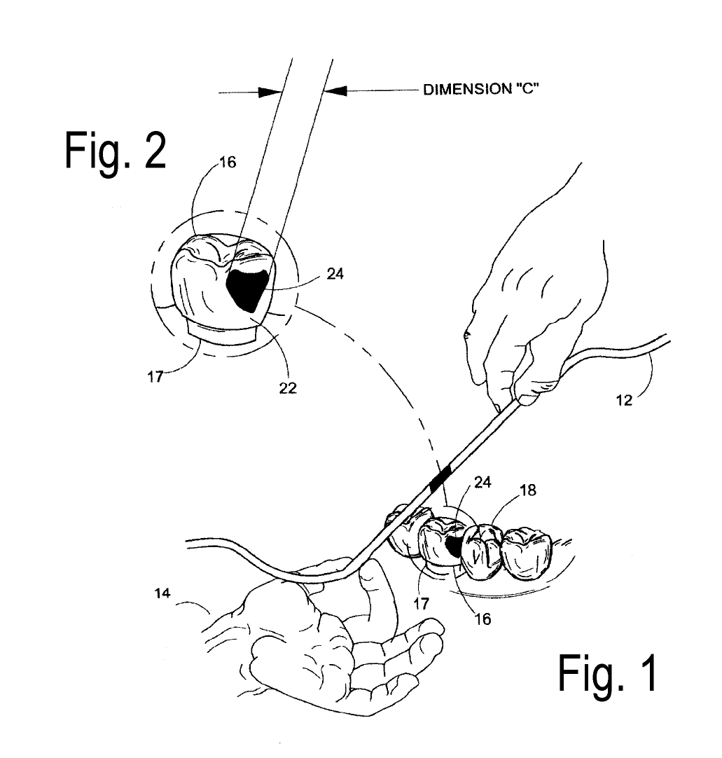

### DETAILED DESCRIPTION OF THE PREFERRED EMBODIMENT

The present invention provides an improved article, system, and method for carrying out the sizing and seating of a dental restoration.

The article of the present invention is a dental floss having disposed there on a material that will produce a colored region on a dental restoration when said article is brought in contact with said dental restoration.

As is known in the art, dental floss has a generally accepted strength of 200-600 M-Pa. A skilled dental practitioner applies pressure from the uppermost part of the tooth in the direction of the gum line and based on the amount of force required to push the dental floss to the gum line between two adjacent teeth, the experienced practitioner knows and understands the sufficiency of the space between the teeth.

In seating a dental restoration, the experienced practitioner measures the seating position of a dental restoration next to and adjacent to buy the amount of pressure required to push the floss from the space between the uppermost part of the tooth and the restoration to the gum line between the restoration and immediately adjacent tooth.

When performing this measurement, the skilled practitioner, based on the amount of force required to position the dental floss along the gum line is able to determine if the restoration needs to be resized in any manner.

System 10 includes floss 12 having disposed thereon a material that will produce a colored region 24 when floss 12 is contacted on restoration 16 with pressure when floss 12 is force between adjacent tooth 18 and restoration 16.

Typically, restoration 16 requires minor adjustments in size in order to properly seat between adjacent teeth 18. The adjustment in size is typically is between 50-500 microns and is accomplished through sanding of the restoration surface.

There is a space, or gap, between adjacent tooth 18 and restoration 16 whereby restoration 16 is placed upon prep to 17 used in the seating and sizing procedure.

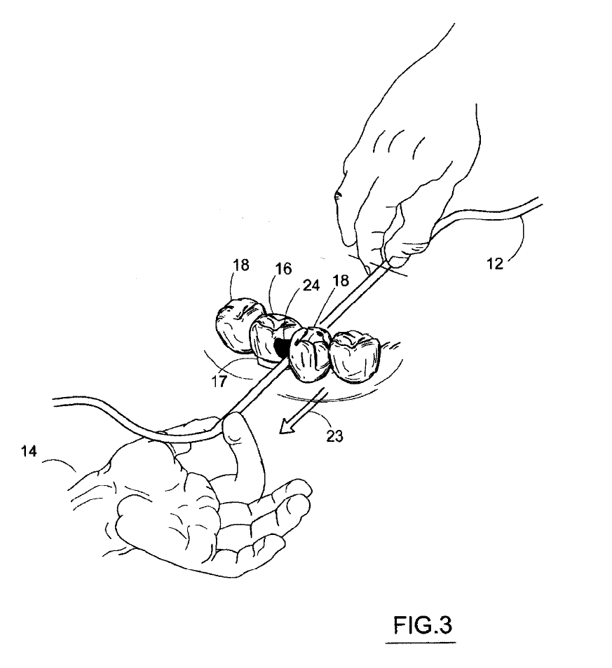

As best seen in FIG. 3 when a dental practitioner positions floss 12 between restoration 16 and adjacent tooth 18 the practitioner hand 14 outside of the patient's mouth moves the floss in the direction 23 outward from the patient's mouth in order to produce indication region 24 on restoration 16.

Indication region 24 demonstrates to the practitioner the area of restoration 16 that is in need of size adjustment. A skilled practitioner is required to seat the restoration accurately in order to ensure comfort to the patient once the restoration is permanently affixed. The practitioner, based on indication region 24 will sand or otherwise resurface restoration 16 along line 22 providing the desired resultant space between restoration 16 and tooth 18. The skilled practitioner determines a desired placement and, if needed, amount of sanding/resurfacing, based on the resistance to the dental floss when positioning the floss between restoration 16 and tooth 18 while moving the floss from the uppermost portion of each of these to a region along the gum line between each of restoration 16 into the 18.

Once the practitioner is satisfied that the size of restoration 16 is proper, restoration 16 will be secured into position.

The present invention further includes a method for the proper seating of a dental restoration, the method comprising the steps of:
providing a dental floss having disposed thereon at least one material constructed and arranged to produce a spot on a dental restoration when said floss is brought in pressurized contact therewith:
positioning a dental restoration on a prep tooth in the mouth of a patient;
positioning said dental floss on the uppermost region between said dental restoration and an adjacent tooth;
applying pressure on said dental floss in order to push said dental floss to the region along the gum line between said restoration and said adjacent tooth, wherein said pressure causes said dental floss to contact the surface of each said restoration and said adjacent tooth;
producing a visible mark on said restoration wherein said mark is indicative of the region of closest proximity between said restoration and said adjacent tooth;
optionally, resizing said restoration based upon said visible mark and said pressure required to push said dental floss to the regional on the gum line between said restoration and said at the adjacent tooth;
optionally, repeating any of the above steps as necessary until the dental practitioner perceives said dental restoration to be of proper size.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A method for the proper seating of a dental restoration, the method comprising the steps of:
providing a dental floss having disposed thereon at least one material constructed and arranged to produce a spot or visible color change on a dental restoration when said floss is brought in pressurized contact with at least one surface:
positioning a dental restoration on a prep tooth in the mouth of a patient;
positioning said dental floss on the uppermost region between said dental restoration and an adjacent tooth;
applying pressure on said dental floss in order to push said dental floss to the region along the gum line between said restoration and said adjacent tooth, wherein said pressure causes said dental floss to contact the surface of each said restoration and said adjacent tooth;
producing a visible mark on said restoration wherein said mark is indicative of the region of closest proximity between said restoration and said adjacent tooth;
optionally, resizing said restoration based upon said visible mark and said pressure required to push said dental floss to the regional on the gum line between said restoration and said at the adjacent tooth;
optionally, repeating any of the above steps as necessary until the dental practitioner perceives said dental restoration to be of proper size.

2. The method of claim 1, wherein said material disposed on said floss is affixed during manufacture of said floss.

3. The method of claim 1, wherein said material disposed on said floss is disposed on said floss within 10 minutes prior to use.

4. The method of claim 1, wherein said spot or visible color change on said floss only occurs in a region resultant to application of pressure.

5. The method of claim 1 whereby said spot or visible color change on said floss is permanent.

6. The method of claim 1 whereby said spot or visible color change on said floss is a reversible color change.
